(19) United States
(12) Patent Application Publication
(10) Pub. No.: US 2017/0148076 A1
(43) Pub. Date: May 25, 2017

(54) METHOD FOR OPERATING PERSONAL INFORMATION BROKERAGE APPARATUS AND METHOD FOR OPERATING CUSTOMIZED PRODUCT PRODUCTION SYSTEM USING THE SAME

(71) Applicant: Electronics and Telecommunications Research Institute, Daejeon (KR)

(72) Inventors: Sung-Joo KANG, Daejeon (KR); In-Geol CHUN, Daejeon (KR); Jae-Ho JEON, Daejeon (KR)

(73) Assignee: Electronics and Telecommunications Research Institute, Daejeon (KR)

(21) Appl. No.: 15/361,113

(22) Filed: Nov. 25, 2016

(30) Foreign Application Priority Data
Nov. 25, 2015 (KR) 10-2015-0165439
Jun. 23, 2016 (KR) 10-2016-0078788

(51) Int. Cl. G06Q 30/06

(52) U.S. Cl. CPC G06Q 30/0621; G06Q 30/0635

(57) ABSTRACT

Disclosed herein are a method for operating personal information brokerage apparatus and a method for operating a customized product production system using the method. The method for operating a personal information brokerage apparatus that mediates a transaction between a purchaser terminal device and a seller terminal device, the method including receiving personal information about a purchaser from the purchaser terminal device, classifying and storing the personal information for each purchaser, receiving product selection information related to a desired purchasing product of the purchaser from the purchaser terminal device, determining whether customized personal information required to produce the desired purchasing product is present in the stored personal information, and transmitting the customized personal information and the product selection information to the seller terminal device that sells the desired purchasing product, based on a result of the determination.

### CROSS REFERENCE TO RELATED APPLICATIONS

This application claims the benefit of Korean Patent Application Nos. 10-2015-0165439, filed Nov. 25, 2015 and 10-2016-0078788, filed Jun. 23, 2016, which are hereby incorporated by reference in their entirety into this application.

### BACKGROUND OF THE INVENTION

1. Technical Field

Embodiments according to the concept of the present invention relate to a method for operating a personal information brokerage apparatus and a method for operating a customized product production system using the method.

2. Description of the Related Art

Since the Second Industrial Revolution, machines have been introduced in the production of products in manufacturing industries. Further, since the Third Industrial Revolution, the mass production of products has been available with the introduction of electronic control technology. Manufacturers have derived products desired by many customers by analyzing market demands, have designed producible products in consideration of product designs, functionality, performance, etc., and have built plants for mass-producing the corresponding products. Further, manufacturers mass-produce a relatively small variety of products while maximizing the availability factor of plants, and sell the produced products to unspecific customers.

Further, with the development of information communication technology such as embedded systems, mobile communication, the Internet of Things (IoT), and cloud computing, manufacturers install software in products and provide services enabling the products to access the Internet. These products are referred to as “smart, connected products”, and examples of implementation thereof include robot cleaners, autonomous vehicles, drones, bio shirts, portable blood glucose monitoring devices, and the like.

Customers wish to reflect their preferences in the functionality, performance, design, etc. of products, but only standardized products, which are produced based on mass production, cannot satisfy various customers' requirements. Therefore, the mass customization (i.e. small quantity batch production)—type manufacturing industry has recently attracted attention.

### SUMMARY OF THE INVENTION

Accordingly, the present invention has been made keeping in mind the above problems occurring in the prior art, and an object of the present invention is to provide a method for operating a personal information brokerage apparatus and a method for operating a customized product production system using the method, which collect personal information about a purchaser (buyer) through a purchaser terminal device and provide the collected personal information to a seller, thus enabling the production of a customized product in which the preference or the like of the purchaser is reflected.

In accordance with an aspect of the present invention to accomplish the above object, there is provided a method for operating a personal information brokerage apparatus that mediates a transaction between a purchaser terminal device and a seller terminal device, the method including receiving personal information about a purchaser from the purchaser terminal device, classifying and storing the personal information for each purchaser, receiving product selection information related to a desired purchasing product of the purchaser from the purchaser terminal device, determining whether customized personal information required to produce the desired purchasing product is present in the stored personal information, and transmitting the customized personal information and the product selection information to the seller terminal device that sells the desired purchasing product, based on a result of the determination.

Receiving the personal information may be configured to receive personal information only for items that are set by the purchaser terminal device to be provided to a seller.

Receiving the personal information may be configured to receive the personal information either at predetermined periods or in real time.

The method may further include, if it is determined that the customized personal information is not present in the stored personal information, requesting the customized personal information from the purchaser terminal device.

The method may further include transmitting one or more product lists provided from the seller terminal device and information of a smart device which is capable of collecting information to produce the product to the purchaser terminal device.

Transmitting the one or more product lists to the purchaser terminal device may be configured to transmit a product list closely related to the personal information, among the product lists, to the purchaser terminal device.

The personal information may include at least one of a preference, an age, an occupation, a life pattern, a surrounding environment, a hobby, physical information, an academic ability, family relations, a daily exercise amount, and types of smart devices of the purchaser.

In accordance with another aspect of the present invention to accomplish the above object, there is provided a method for operating a customized product production system, including receiving, by a personal information brokerage apparatus, personal information collected for items set by a purchaser from a purchaser terminal device, classifying and storing, by the personal information brokerage apparatus, the personal information for each purchaser, receiving, by the personal information brokerage apparatus, product selection information related to a desired purchasing product of the purchaser from the purchaser terminal device, determining, by the personal information brokerage apparatus, whether customized personal information required to produce the desired purchasing product is present in the stored personal information, transmitting, by the personal information brokerage apparatus, the customized personal information and the product selection information to a seller terminal device that sells the desired purchasing product, based on a result of the determination, and enabling, by the seller terminal device, production of the desired purchasing product in which the customized personal information is reflected based on the product selection information.

Receiving the personal information may be configured to receive the personal information either at predetermined periods or in real time.

The method may further include, if it is determined that the customized personal information is not present in the stored personal information, requesting, by the personal information brokerage apparatus, the customized personal information from the purchaser terminal device.

The method may further include collecting, by the purchaser terminal device, the customized personal information in real time in response to the customized personal information request, and transmitting, by the purchaser terminal device, the collected customized personal information to the personal information brokerage apparatus.

The method may further include transmitting, by the personal information brokerage apparatus, one or more product lists provided from the seller terminal device and information of a smart device which is capable of collecting information to produce the product to the purchaser terminal device.

Transmitting the one or more product lists to the purchaser terminal device may be configured to transmit a product list closely related to the personal information, among the product lists, to the purchaser terminal device.

Enabling the production of the desired purchasing product may include, if personal information about the purchaser is additionally required in order to produce the desired purchasing product, requesting, by the seller terminal device, additional personal information from the personal information brokerage apparatus, and enabling, by the seller terminal device, the production of the desired purchasing product in consideration of the additional personal information and the customized personal information, which are provided from the personal information brokerage apparatus based on the product selection information.

The personal information may include at least one of a preference, an age, an occupation, a life pattern, a surrounding environment, a hobby, physical information, an academic ability, family relations, a daily exercise amount, and types of smart devices of the purchaser.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a schematic block diagram showing a customized product production system according to an embodiment of the present invention;

FIG. 2 is a schematic block diagram of the purchaser terminal device shown in FIG. 1;

FIG. 3 is a schematic block diagram of the personal information brokerage apparatus shown in FIG. 1;

FIG. 4 is a conceptual diagram for explaining a method by which the personal information brokerage apparatus collects personal information about purchasers according to an embodiment of the present invention;

FIG. 5 is a flowchart for explaining a method for operating a purchaser terminal device according to an embodiment of the present invention;

FIG. 6 is a flowchart for explaining a method for operating the personal information brokerage apparatus according to an embodiment of the present invention; and

FIG. 7 is a flowchart for explaining a method for operating a seller terminal device according to an embodiment of the present invention.

### DESCRIPTION OF THE PREFERRED EMBODIMENTS

Specific structural or functional descriptions related to embodiments based on the concept of the present invention and disclosed in the present specification are merely illustrated to describe embodiments based on the concept of the present invention, and the embodiments based on the concept of the present invention may be implemented in various forms, and should not be interpreted as being limited to the above embodiments described in the present specification.

The embodiments based on the concept of the present invention may be modified in various manners and may have various forms, and thus the embodiments are intended to be illustrated in the drawings and described in detail in the present specification. However, it should be understood that those embodiments are not intended to limit the embodiments based on the concept of the present invention to specific disclosure forms and they include all changes, equivalents or modifications included in the spirit and scope of the present invention.

Terms such as “first” or “second” may be used to describe various components, but those components should not be limited by the terms. The terms are merely used to distinguish one component from other components, and a first component may be designated as a second component and a second component may be designated as a first component in a similar manner, without departing from the scope based on the concept of the present invention.

It should be understood that a representation indicating that a first component is “connected” or “coupled” to a second component may include the case where the first component is connected or coupled to the second component with some other component interposed therebetween, as well as the case where the first component is “directly connected” or “directly coupled” to the second component. In contrast, it should be understood that a representation indicating that a first component is “directly connected” or “directly coupled” to a second component means that no component is interposed between the first and second components. Other representations describing relationships among components, that is, “between” and “directly between” or “adjacent to,” and “directly adjacent to,” should be interpreted in a like fashion.

The terms used in the present specification are merely used to describe specific embodiments and are not intended to limit the present invention. A singular expression includes a plural expression unless a description to the contrary is specifically pointed out in context. In the present specification, it should be understood that the terms such as “include” or “have” are merely intended to indicate that features, numbers, steps, operations, components, parts, or combinations thereof that are described in the present specification are present, and are not intended to exclude the possibility that one or more other features, numbers, steps, operations, components, parts, or combinations thereof will be present or added.

Unless differently defined, all terms used here including technical or scientific terms have the same meanings as terms generally understood by those skilled in the art to which the present invention pertains. The terms identical to those defined in generally used dictionaries should be interpreted as having meanings identical to contextual meanings of the related art, and are not interpreted as being ideal or excessively formal meanings unless they are definitely defined in the present specification.

In the present specification, the expression “exchanging information (or data) using a personal information brokerage apparatus” means that information (or data) is transmitted or received between communication devices (e.g. network interfaces) installed on computers or smart devices under the control of the personal information brokerage apparatus.

Further, in the present specification, the term “module” may denote hardware or a functional or structural combination of software for driving the hardware to implement the methods according to embodiments of the present invention. For example, the module may denote a logical unit or set of a program code and hardware resources for executing the program code, but it does not necessarily mean a physically connected code or a type of hardware.

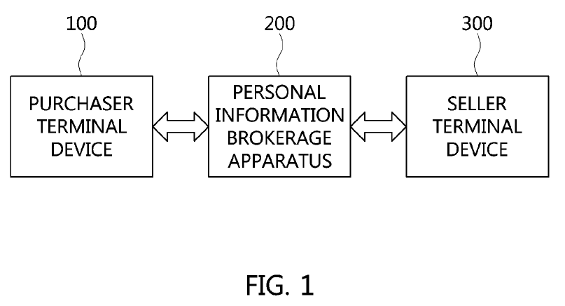

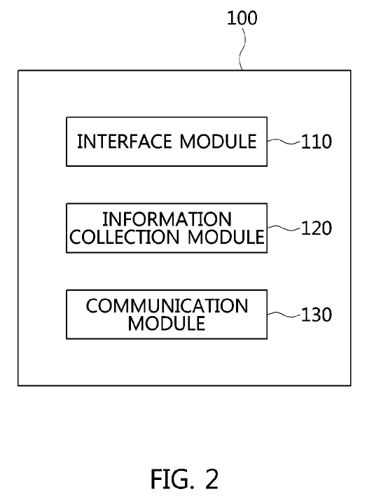

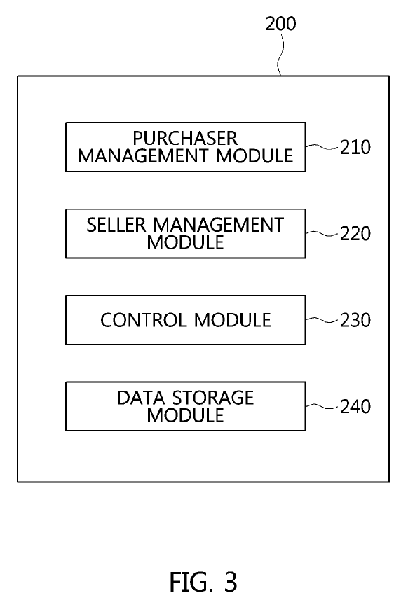

FIG. 1 is a schematic block diagram of a customized product production system according to an embodiment of the present invention, FIG. 2 is a schematic block diagram of the purchaser terminal device, shown in FIG. 1, and FIG. 3 is a schematic block diagram of the personal information brokerage apparatus, shown in FIG. 1.

In order to switch the existing production scheme to a mass customization scheme (small quantity batch production), changes are needed in the overall procedure for Product Lifecycle Management (PLM) in the existing manufacturing industry. More specifically, there are representative changes, such as a change from a scheme for deriving products desired by many customers by analyzing market demands to a scheme for directly deriving requirements for products from a target customer, a change from a product design for unspecified persons to the design of a product in which the requirements of a specific customer are reflected, and a change from a production system for mass-producing an identical product to a flexible production system capable of rapidly producing various types of products through a dynamic production line.

When a customized product is developed through the above procedure, the highest priority is assigned to the acquisition of information about target customers by the manufacturer who desires to develop the customized product. Methods for acquiring customer information include a method of personally meeting a customer and interviewing the customer or a method of measuring the customer's product usage pattern. However, it is difficult to obtain responses that satisfy the criteria of manufacturers from all customers, and it is possible to derive requirements that are not perceived by the customers from big data on customers, which has accumulated for a long period, even if the requirements are not determined in a demand prediction stage.

For example, for a robot cleaner, the same product is sold to several hundreds of thousands of customers and is driven to perform its task in each home. However, respective house environments, such as the structures of respective houses, the arrangement of furniture, the height of door sills, and the materials of floors, may differ.

Accordingly, when an individual customer uses a robot cleaner, there are several cases where tasks desired by the customer cannot be performed, such as the case where the robot cleaner cannot cross a door sill and thus fails to clean a specific region due to the excessively high door sill, the case where the robot cleaner may enter an inoperable state because it is caught in a crevice in furniture, or the case where the wheel of the robot cleaner slips and spins due to the slippery material of the floor, resulting in undesirable cleaning results.

In this case, when a manufacturer visits the target house, measures the structure of the house, and produces a separate robot cleaner, a customized product that perfectly fits the house of the customer may be provided, but this is inefficient from the standpoint of expenses.

Meanwhile, respective individuals have recently come to use various kinds of electronic devices including smart devices (smart, connected products) such as a smart home device, a smart phone, smart glasses, a smart TV, a smart refrigerator, and a smart watch, in his or her daily life. These devices may collect information about the environment surrounding each individual without the individual being aware of the information collection, and the collected information may be utilized when a product customized for the corresponding customer is developed.

For example, the arrangement of furniture observed through smart glasses, the structure of a house managed by a smart home device, and the time that each occupant leaves the house, as measured by a smart phone, may be utilized when the design, parts, an artificial intelligence system, etc. of a robot cleaner are implemented.

Referring to FIG. 1, the customized product production system according to the embodiment of the present invention includes a purchaser terminal device 100, a personal information brokerage apparatus 200, and a seller terminal device 300.

The purchaser terminal device 100 may receive one or more product lists from the personal information brokerage apparatus 200.

A purchaser (buyer) may select a product desired to be purchased from the product lists displayed on the purchaser terminal device 100, and the purchaser terminal device 100 may transmit product selection information based on the result of the selection by the purchaser to the personal information brokerage apparatus 200.

In accordance with an embodiment, the purchaser terminal device 100 may mean, but is not limited to, a personal computer (PC), a smart phone, a tablet PC, a Mobile Internet device (MID), an Internet tablet, an Internet of Things (IoT) device, an Internet of Everything (IoE) device, a desktop computer, a laptop computer, a workstation computer, or a Personal Digital Assistant (PDA).

The purchaser terminal device 100 may collect all of pieces of personal information related to the purchaser. For example, the purchaser terminal device 100 may collect information such as the preference, age, occupation, life pattern (behavior pattern), surrounding environment, hobby, physical information, academic ability, family relations, daily exercise amount, and types of smart devices of the purchaser.

The purchaser terminal device 100 may collect personal information only for items that the purchaser has permitted to be collected. Here, the purchaser terminal device 100 may automatically collect all personal information related to the permitted items.

For example, when the purchaser terminal device 100 is capable of collecting information such as the daily walking time and running time of the purchaser, but the purchaser sets the corresponding item such that only the daily walking time can be collected, the purchaser terminal device 100 may collect information only about the daily walking time.

In this way, once the purchaser sets items in the purchaser terminal device 100, the purchaser terminal device 100 may automatically collect all personal information related to the corresponding items, and thus the purchaser does not need to take any separate action for providing personal information to a seller.

The purchaser terminal device 100 may transmit the collected personal information to the personal information brokerage apparatus 200 either in real time or periodically.

The personal information brokerage apparatus 200 may mediate transactions between the purchaser terminal device 100 and the seller terminal device 300.

According to an embodiment, the personal information brokerage apparatus 200 may be implemented as a server connected both to the purchaser terminal device 100 and to the seller terminal device 300 over a network. Here, the network may denote the Internet, the wireless Internet or a WiFi network.

The personal information brokerage apparatus 200 may store the personal information received from the purchaser terminal device 100. The personal information brokerage apparatus 200 may classify and store pieces of personal information for respective purchasers.

For example, when a first purchaser has a plurality of purchaser terminal devices 100, all of the personal information received from the purchaser terminal devices 100 may be stored as personal information about the first purchaser.

In an embodiment, the personal information brokerage apparatus 200 may store the personal information in a separately provided database (DB).

The personal information brokerage apparatus 200 may transmit product lists provided from the seller terminal device 300 to the corresponding purchaser terminal device 100 either in a push manner or in response to a request received from the purchaser terminal device 100.

In an embodiment, the personal information brokerage apparatus 200 may select a product list, which is closely related to the prestored personal information, from among the product lists provided from the seller terminal device 300 and information of a smart device which is capable of collecting information to produce the product, and may transmit the selected product list to the purchaser having the corresponding personal information.

For example, when receiving a list of health supplement food products from the seller terminal device 300, the personal information brokerage apparatus 200 may select personal information related to health from among the prestored personal information about the purchaser, and may provide the list of health supplement food products to the purchaser terminal device 100 of the corresponding purchaser.

In a more sophisticated example, when the personal information brokerage apparatus 200 stores personal information related to the sleeping habits of the purchaser, the personal information brokerage apparatus 200 may select purchasers who sleep for a time shorter than an average sleeping time, and may transmit the list of health supplement food products to the purchaser terminal devices 100 of the corresponding purchasers.

Further, the personal information brokerage apparatus 200 may determine whether personal information corresponding to a desired purchasing product included in the product selection information is present. That is, the personal information brokerage apparatus 200 may determine whether customized personal information that is required in order to produce the desired purchasing product is present in the prestored personal information.

For example, when the desired purchasing product is sneakers, the personal information brokerage apparatus 200 may determine whether the personal information that is required in order to produce sneakers regarding a smart device which is capable of collecting the personal information, for example, the shoe size of the purchaser, the shoe color and shoestring color preferred by the purchaser, the material of sneakers usually worn by the purchaser, or the like, is present in the prestored personal information.

The personal information brokerage apparatus 200 may transmit the customized personal information and the product selection information to the seller terminal device 300 that sells the desired purchasing product, based on the result of the determination.

If it is determined that the customized personal information that is required in order to produce the desired purchasing product is prestored, the personal information brokerage apparatus 200 may provide the product selection information, together with the customized personal information, to the seller terminal device 300.

On the other hand, if it is determined that the customized personal information that is required in order to produce the desired purchasing product is not prestored, the personal information brokerage apparatus 200 may request customized personal information from the purchaser terminal device 100.

For example, when the desired purchasing product selected by the purchaser is sneakers, the personal information brokerage apparatus 200 may request the purchaser terminal device 100 to additionally collect personal information that is required in order to produce sneakers, for example, the shoe size of the purchaser, the shoe color and shoestring color preferred by the purchaser, and the material of sneakers usually worn by the purchaser.

When the customized personal information is received from the purchaser terminal device 100, the personal information brokerage apparatus 200 may transmit the received customized personal information and the product selection information to the seller terminal device 300.

The seller terminal device 300 may transmit one or more product lists and information of a smart device which is capable of collecting information to produce the product to the personal information brokerage apparatus 200, and may enable the production of the desired purchasing product using both the customized personal information and the product selection information received from the personal information brokerage apparatus 200.

According to an embodiment, the seller terminal device 300 may mean, but is not limited to, a PC, a smart phone, a tablet PC, a Mobile Internet Device (MID), an Internet tablet, an IoT device, an IoE device, a desktop computer, a laptop computer, a workstation computer, or a PDA.

When the personal information about the purchaser is sufficient to produce the desired purchasing product included in the product selection information, that is, when the desired purchasing product may be produced based on the customized personal information, the seller terminal device 300 enables the production of the desired purchasing product in which the customized personal information is reflected.

For example, when a desired purchasing product included in the product selection information is sneakers, and the customized personal information contains personal information required to produce sneakers, such as the shoe size of the purchaser, the shoe color and shoestring color preferred by the purchaser, and the material of sneakers usually worn by the purchaser, the seller of the seller terminal device 300 may produce the desired purchasing product, that is, customized sneakers, in which the customized personal information is reflected.

However, when additional personal information about the purchaser is required in order to produce the desired purchasing product, the seller terminal device 300 may request additional personal information from the personal information brokerage apparatus 200. In this case, the personal information brokerage apparatus 200 may forward the request for additional personal information to the purchaser terminal device 100 in response to the request for additional personal information, and the purchaser terminal device 100 may newly collect the additional personal information.

Thereafter, the seller terminal device 300 may receive the additional personal information through the personal information brokerage apparatus 200, and the seller may produce the desired purchasing product in which the newly collected additional personal information is reflected.

In this way, the customized product production system according to the embodiment of the present embodiment may collect the personal information about the purchaser using the purchaser terminal device 100, and may provide the personal information to the seller through the personal information brokerage apparatus 200, thus enabling a customized product optimized for the purchaser to be produced.

Referring to FIG. 2, the purchaser terminal device 100 may include an interface module 110, an information collection module 120, and a communication module 130.

The interface module 110 may provide various functions required by the purchaser in order to use the purchaser terminal device 100, and may mean all of a series of components that can be controlled or managed by the purchaser when the purchaser accesses the individual components of the purchaser terminal device 100.

For example, the interface module 110 may mean wired/wireless data ports for functioning as paths with various external devices, or may mean a Graphical User Interface (GUI) or the like.

In accordance with an embodiment, the purchaser terminal device 100 may display each product list to the purchaser using the interface module 110, and may allow a product to be selected by the purchaser. Further, the interface module 110 allows the setting of items related to personal information to be provided from the purchaser to the seller.

The information collection module 120 may collect personal information about the purchaser.

According to an embodiment, the information collection module 120 may include, but is not limited to, an acceleration sensor, a vibration sensor, a sound analysis module, an image interpretation module, etc., and may mean all components capable of collecting the personal information about the purchaser.

For example, the information collection module 120 may measure the daily average walking time, daily average running time, etc. of the purchaser using the vibration sensor and the acceleration sensor, may capture an image of the environment surrounding the purchaser using the camera or the like, and may analyze the surrounding environment included in the captured image using the image interpretation module. Furthermore, the information collection module 120 may record the breathing sound of the purchaser and then analyze the daily sleeping time of the purchaser using the sound analysis module.

The communication module 130 may communicate with the personal information brokerage apparatus 200. That is, the communication module 130 may receive the product lists from the personal information brokerage apparatus 200 and may transmit both the collected personal information and the product selection information to the personal information brokerage apparatus 200.

According to an embodiment, the communication module 130 may transmit the collected personal information and the product selection information to other purchaser terminal devices 100 connected thereto.

Referring to FIG. 3, the personal information brokerage apparatus 200 may include a purchaser management module 210, a seller management module 220, a control module 230, and a data storage module 240.

The purchaser management module 210 may assign respective identifiers to the purchaser terminal devices 100 connected to the personal information brokerage apparatus 200 and to the purchaser.

For example, when the purchaser requests registration as a member from the personal information brokerage apparatus 200 through the purchaser terminal device 100, the purchaser management module 210 may assign respective identifiers to the purchaser and to the purchaser terminal device 100.

Further, the purchaser management module 210 may control functions, such as the management of information to be collected by respective purchaser terminal devices 100, the management of the present states of customized products being produced, and the management of inquiries about customized products.

The seller management module 220 may assign respective identifiers to the seller terminal device 300 connected to the personal information brokerage apparatus 200 and to the seller.

For example, when the seller requests registration as a member from the personal information brokerage apparatus 200 through the seller terminal device 300, the seller management module 220 may assign respective identifiers to the seller and to the seller terminal device 300.

Further, the seller management module 220 may manage requests for customized product production, which have been transmitted to the seller, and may set information useful for the production of customized products.

The control module 230 may determine whether customized personal information that is required in order to produce a desired purchasing product is present in the prestored personal information. The control module 230 may control the transmission of information so that both the customized personal information and the product selection information are transmitted to the seller terminal device 300 that sells the desired purchasing product, based on the result of the determination.

The data storage module 240 may store the personal information received from the purchaser terminal device 100. Further, the data storage module 240 may store purchaser member registration information, seller member registration information, product management information, information about each purchaser terminal device 100, information about each seller terminal device 300, information about product production requests, etc.

According to an embodiment, the personal information brokerage apparatus 200 may store the personal information in a database (DB) separately connected to the data storage module 240.

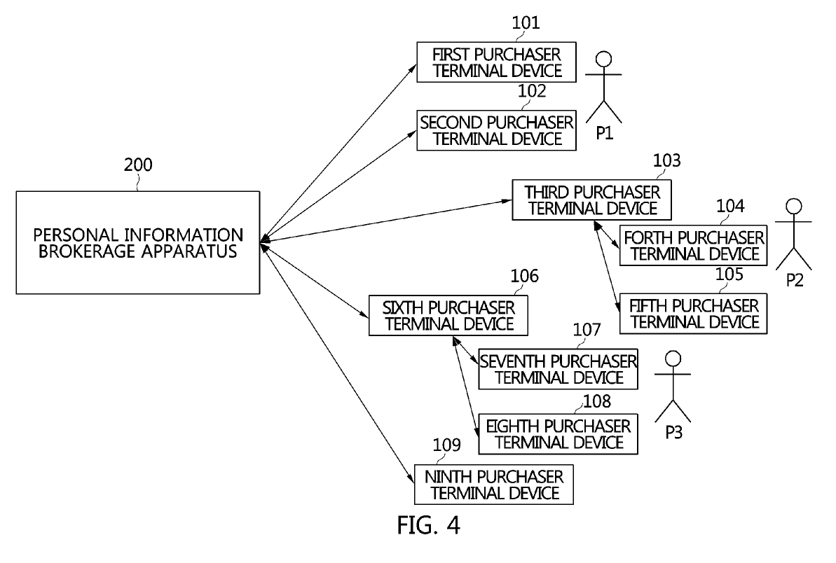

FIG. 4 is a conceptual diagram for explaining a method by which the personal information brokerage apparatus collects personal information about purchasers according to an embodiment of the present invention.

Referring to FIG. 4, the personal information brokerage apparatus 200 may be connected to multiple purchaser terminal devices 100. Each of purchasers may include one or more purchaser terminal devices 100, and each of the purchaser terminal devices 100 may be connected in series or parallel to the personal information brokerage apparatus 200.

Each purchaser may possess one or more purchaser terminal devices 100, and the purchaser terminal devices 100 may be classified into a normal terminal device and a representative terminal device for collecting personal information from each subordinate purchaser terminal device 100, depending on the functions performed by the purchaser terminal devices 100.

The normal terminal device may directly transmit the personal information about the purchaser to the personal information brokerage apparatus 200, or may transmit the personal information to the personal information brokerage apparatus 200 through the representative terminal device.

In contrast, the representative terminal device may directly transmit the personal information received from a subordinate purchaser terminal device 100 to the subordinate personal information brokerage apparatus 200.

For example, a first purchaser P1 may include a first purchaser terminal device 101 and a second purchaser terminal device 102, which are normal terminal devices, and each of the first and second purchaser terminal devices 101 and 102 may collect personal information about the first purchaser P1 and directly transmit the collected personal information to the personal information brokerage apparatus (server).

For example, a second purchaser P2 may include a third purchaser terminal device 103, which is a representative terminal device, and a fourth purchaser terminal device 104 and a fifth purchaser terminal device 105, which are normal terminal devices. Each of the fourth and fifth purchaser terminal devices 104 and 105 may collect personal information about the second purchaser P2, and may transmit the collected personal information to the brokerage apparatus (server) through the third purchaser terminal device 103.

For example, a third purchaser P3 may include a sixth purchaser terminal device 106, which is a representative terminal device, and a seventh purchaser terminal device 107, an eighth purchaser terminal device 108, and a ninth purchaser terminal device 109, which are normal terminal devices. Each of the seventh and eighth purchaser terminal devices 107 and 108 may collect personal information about the third purchaser P3 and may transmit the collected personal information to the personal information brokerage apparatus (server) through the sixth purchaser terminal device 106. Here, the ninth purchaser terminal device 109 may collect personal information about the third purchaser P3 and directly transmit the collected personal information to the personal information brokerage server.

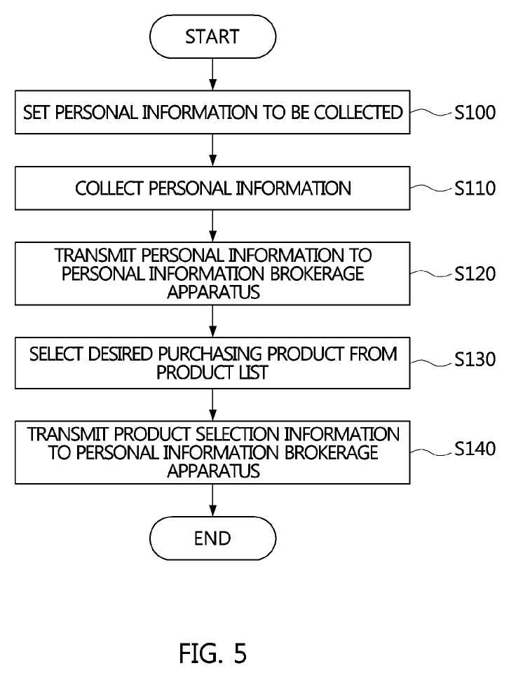

FIG. 5 is a flowchart for explaining a method for operating the purchaser terminal device according to an embodiment of the present invention.

Referring to FIG. 5, the purchaser terminal device may set items of personal information to be collected at step S100. The purchaser terminal device 100 may collect personal information only for the items permitted to be collected either in real time or at preset periods at step S110.

The purchaser terminal device 100 may transmit the personal information to the personal information brokerage apparatus 200 at step S120.

The purchaser terminal device 100 may select a desired purchasing product from each product list received from the personal information brokerage apparatus 200 at step S130, and may transmit product selection information containing the desired purchasing product to the personal information brokerage apparatus 200 at step S140.

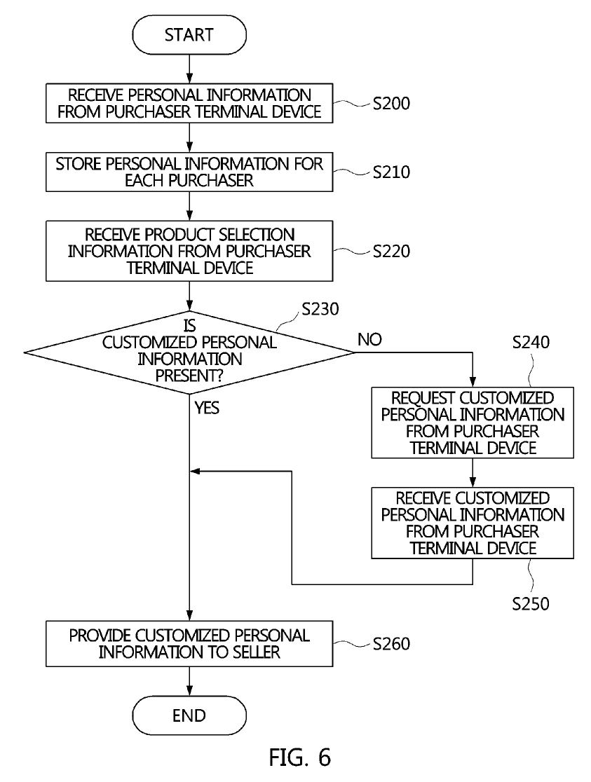

FIG. 6 is a flowchart for explaining a method for operating the personal information brokerage apparatus according to an embodiment of the present invention.

Referring to FIG. 6, when personal information is received from each purchaser terminal device 100 at step S200, the personal information brokerage apparatus 200 may store the personal information for each purchaser in the data storage module 240 or in the DB at step S210.

When product selection information is received from the purchaser terminal device 100, the personal information brokerage apparatus 200 may determine whether customized personal information that is required in order to produce a desired purchasing product contained in the product selection information is present in the stored personal information at step S230.

If it is determined that customized personal information is not present in the stored personal information, the personal information brokerage apparatus 200 may request additional personal information that is required in order to produce the desired purchasing product from the purchaser terminal device 100 at step S240.

The personal information brokerage apparatus 200 may receive newly collected additional personal information from the purchaser terminal device 100 at step S250, and may transmit the newly collected additional personal information as customized personal information to the seller terminal device 300.

On the other hand, if it is determined that customized personal information is present in the stored personal information, the personal information brokerage apparatus 200 may transmit the customized personal information to the seller terminal device 300 at step S260.

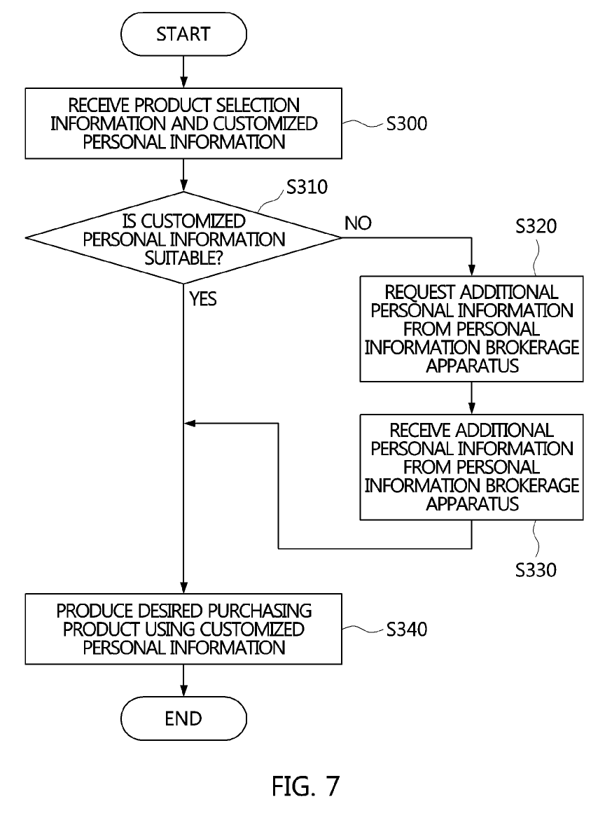

FIG. 7 is a flowchart for explaining a method for operating the seller terminal device according to an embodiment of the present invention.

Referring to FIG. 7, when product selection information containing a desired purchasing product and customized personal information are received at step S300, the seller terminal device 300 may determine whether the received customized personal information is suitable information that is required in order to produce the desired purchasing product at step S310.

If it is determined that the customized personal information is not suitable information that is required in order to produce the desired purchasing product, the seller terminal device 300 may request additional personal information required in order to produce the desired purchasing product at step S320.

The seller terminal device 300 may receive the newly collected additional personal information from the personal information brokerage apparatus 200 at step S330, and may request a seller to produce the desired purchasing product.

If it is determined that the customized personal information is suitable information that is required in order to produce the desired purchasing product, the seller terminal device 300 may request the seller to produce the desired purchasing product at step S340.

In accordance with the method for operating the personal information brokerage apparatus and the method for operating the customized product production system using the method according to the embodiments of the present invention, automatically collected personal information may be provided to a seller, and thus a customized product in which the preference or the like of each purchaser is reflected may be produced.

In accordance with the method for operating the personal information brokerage apparatus and the method for operating the customized product production system using the method according to the embodiments of the present invention, inconvenience that requires the preference information or the like of a purchaser to be manually provided to a seller in order for the purchaser to purchase a customized product may be minimized.

The brokerage apparatus, the purchaser terminal device and the seller terminal device may be implemented using one or more hardware components, software components, and/or a combination thereof. For example, the brokerage apparatus may be implemented using one or more general-purpose or special purpose computer, such as, for example, a processor, a controller, a microcomputer, a microprocessor, or any other device capable of responding to and executing instructions.

Although the present invention has been described with reference to the embodiments illustrated in the attached drawings, the embodiments are merely exemplary, and those skilled in the art will appreciate that various modifications, additions and substitutions are possible, without departing from the scope and spirit of the invention as disclosed in the accompanying claims. Therefore, the technical scope of the present invention should be defined by the technical spirit of the accompanying claims.

What is claimed is:

1. A method for processing personal information to customize a transaction between a purchaser terminal device and a seller terminal device, the method comprising:
by at least one hardware processor:
receiving personal information related to a purchaser from the purchaser terminal device;
storing the received personal information;
receiving product selection information related to a product selected to be purchased by the purchaser from the purchaser terminal device;
determining whether customized personal information useable to customize production of the selected product to the purchaser exists among the stored personal information; and
transmitting the customized personal information and the product selection information to the seller terminal device configured to sell the selected product, based on a result of the determination.

2. The method of claim 1, wherein the received personal information is associated with items of information that are set by the purchaser terminal device to be provided to a seller.

3. The method of claim 1, wherein the receiving of the personal information occurs either during a predetermined period or in real time.

4. The method of claim 1, further comprising:
requesting the customized personal information from the purchaser terminal device when the determining determines that the customized personal information does not exist among the stored personal information.

5. The method of claim 1, further comprising:
transmitting one or more product lists provided from the seller terminal device and information of an electronic device configured to collect information useable to customize production of the selected product to the purchaser terminal device.

6. The method of claim 5, wherein the transmitting of the one or more product lists includes transmitting a product list among the one or more product lists to the purchaser terminal device when the product list is closely related to the personal information than other said one or more product lists.

7. The method of claim 1, wherein the personal information comprises information of any one or combination of a preference, an age, an occupation, a life pattern, a surrounding environment, a hobby, physical information, an academic ability, family relations, a daily exercise amount, and types of smart devices of the purchaser.

8. A method for operating a customized product production system, comprising:
by at least one hardware processor:
receiving personal information collected for items set by a purchaser from a purchaser terminal device;
storing the personal information related to the purchaser;
receiving product selection information related to a product selected to be purchased by the purchaser from the purchaser terminal device;
determining whether customized personal information useable to customize production of the selected product to the purchaser exists among the stored personal information;
transmitting the customized personal information and the product selection information to a seller terminal device configured to sell product, based on a result of the determination so as to enable the seller terminal device production of the selected product in which the customized personal information is reflected based on the product selection information.

9. The method of claim 8, wherein to received personal information occurs either during a predetermined period or in real time.

10. The method of claim 8, further comprising:
requesting the customized personal information from the purchaser terminal device when the determining determines that the customized personal information does not exist among the stored personal information.

11. The method of claim 10, further comprising:
collecting, by the purchaser terminal device, the customized personal information in real time in response to the requesting of the customized personal information; and
transmitting, by the purchaser terminal device, the collected customized personal information to a personal information brokerage apparatus.

12. The method of claim 8, further comprising:
transmitting one or more product lists provided from the seller terminal device and information of an electronic device configured to collect information useable to customize production of the selected product to the purchaser terminal device.

13. The method of claim 12, wherein the transmitting of the one or more product lists includes transmitting a product list among the one or more product lists to the purchaser terminal device when the product list is closely related to the personal information than other said one or more product lists.

14. The method of claim 8, further comprising:
requesting additional personal information when determining the additional personal information is required to customize production of the selected product; and
wherein the seller terminal device is enabled to consider the additional personal information and the customized personal information for the production of the selected product.

15. The method of claim 8, wherein the personal information comprises information of any one or combination of a preference, an age, an occupation, a life pattern, a surrounding environment, a hobby, physical information, an academic ability, family relations, a daily exercise amount, and types of smart devices of the purchaser.

16. An apparatus for processing personal information to customize a transaction between a purchaser terminal device and a seller terminal device, comprising:
a memory; and
at least one hardware processor:
receiving personal information related to a purchaser from the purchaser terminal device;
storing the received personal information in the memory;
receiving product selection information related to a product selected to be purchased by the purchaser from the purchaser terminal device;
determining whether customized personal information useable to customize production of the selected product to the purchaser exists among the stored personal information; and
transmitting the customized personal information and the product selection information to the seller terminal device configured to sell the selected product, based on a result of the determination.
